(19) United States
(12) Patent Application Publication
(10) Pub. No.: US 2015/0381899 A1
(43) Pub. Date: Dec. 31, 2015

(54) IMAGE PROCESSING APPARATUS AND IMAGE PROCESSING METHOD FOR SYNTHESIZING PLURALITY OF IMAGES

(71) Applicant: CASIO COMPUTER CO., LTD., Tokyo (JP)

(72) Inventor: Kouichi SAITOU, Iruma-shi (JP)

(73) Assignee: CASIO COMPUTER CO., LTD., Tokyo (JP)

(21) Appl. No.: 14/745,877

(22) Filed: Jun. 22, 2015

(30) Foreign Application Priority Data
Jun. 30, 2014 (JP) 2014-135264

(51) Int. Cl. H04N 5/262; H04N 5/272; H04N 5/232

(52) U.S. Cl. CPC H04N 5/262; H04N 5/23219; H04N 5/272; H04N 5/23293

(57) ABSTRACT

An image processing apparatus 1 includes an imaging control unit 51, a face recognition unit 52, a synthesis position analysis unit 54, and an image synthesis unit 55. The imaging control unit 51 acquires a first image and a second image. The face recognition unit 52 determines relevance between a subject of the first image and a subject of the second image. The synthesis position analysis unit 54 decides the synthesis position of the second image in the first image on the basis of the relevance between the subjects determined by the face recognition unit 52. The image synthesis unit 55 synthesizes the first image and the second image in the synthesis position decided by the synthesis position analysis unit 54.

### CROSS-REFERENCE TO RELATED APPLICATIONS

This application is based upon and claims the benefit of priority under 35 USC 119 of Japanese Patent Application 2014-135264 filed on Jun. 30, 2014 the entire disclosure of which, including the description, claims, drawings, and abstract, is incorporated herein by reference in its entirety.

### BACKGROUND OF THE INVENTION

1. Field of the Invention

The present invention relates to an image processing apparatus and an image processing method for synthesizing a plurality of images.

2. Background Art

Conventionally, there has been known a technique of generating a synthetic image enabling a plurality of images acquired from a plurality of imaging apparatuses to be displayed simultaneously.

For example, Patent Document 1 describes a technique of transparentizing a partial removed region in one image and synthesizing the image into the other image.
[Patent Document 1] Japanese Patent Application Laid-Open No. 2009-253554

### SUMMARY OF THE INVENTION

According to one aspect of the present invention, there is provided an image processing apparatus including: an image acquisition unit configured to acquire a first image and a second image; a relevance determination unit configured to determine relevance between a subject of the first image and a subject of the second image; a decision unit configured to decide a synthesis position of the second image in the first image based on the relevance between the subjects determined by the relevance determination unit; and an image synthesis unit configured to synthesize the first image and the second image in the synthesis position decided by the decision unit.

According to another aspect of the present invention, there is provided an image processing apparatus including: an image acquisition unit configured to acquire a first image taken in a first direction by a first imaging unit and a second image taken in a second direction by a second imaging unit which is different from the first imaging unit; a region identification unit configured to identify a region where the second image is to be synthesized in the first image acquired by the image acquisition unit; a decision unit configured to decide a synthesis position of the second image in the first image in the region identified by the region identification unit; and an image synthesis unit configured to synthesize the first image and the second image in the synthesis position decided by the decision unit.

According to yet another aspect of the present invention, there is provided an image processing apparatus including: an image acquisition unit configured to acquire a first image taken in a first direction and a second image taken in a second direction simultaneously and sequentially; a first display control unit configured to sequentially display the first image and the second image acquired by the image acquisition unit on a display unit; a first input unit configured to input a first predetermined instruction during the display of the first image and the second image performed by the first display control unit; a second display control unit configured to control the display of one of the first image and the second image to be fixed and the other of the first image and the second image to be continuously displayed in the case where the first input unit inputs the first predetermined instruction; a second input unit configured to input a second predetermined instruction during the display of the first image and the second image displayed on the display unit by the second display control unit; and a synthesis unit configured to synthesize the first image corresponding to a time point when the first input unit inputs the first predetermined instruction and the second image corresponding to a time point when the second input unit inputs the second predetermined instruction.

According to still another aspect of the present invention, there is provided an image processing apparatus including: an image acquisition unit configured to acquire a first image taken in a first direction and a second image taken in a second direction in association with the imaging of the first image; a generation unit configured to generate a plurality of candidate images each in which the second image is synthesized in one of a plurality of positions in the first image; a display control unit configured to display the plurality of candidate images generated by the generation unit on a display unit; a selection unit configured to select a specific candidate image out of the plurality of candidate images displayed on the display unit by the display control unit; and a recording control unit configured to record the specific candidate image selected by the selection unit on a recording unit.

According to still another aspect of the present invention, there is provided an image processing method including: an image acquisition step of acquiring a first image and a second image; a relevance determination step of determining relevance between a subject of the first image and a subject of the second image; a decision step of deciding a synthesis position of the second image in the first image based on the relevance between the subjects determined in the relevance determination step; and an image synthesis step of synthesizing the first image and the second image in the synthesis position decided in the decision step.

According to still another aspect of the present invention, there is provided an image processing method used in an image processing apparatus, the method including: an image acquisition step of acquiring a first image taken in a first direction by a first imaging unit and a second image taken in a second direction by a second imaging unit which is different from the first imaging unit; a region identification step of identifying a region where the second image is to be synthesized in the first image acquired in the image acquisition step; a decision step of deciding a synthesis position of the second image in the first image in the region identified in the region identification step; and an image synthesis step of synthesizing the first image and the second image in the synthesis position decided in the decision step.

According to still another aspect of the present invention, there is provided an image processing method used in an image processing apparatus, the method including: an image acquisition step of acquiring a first image taken in a first direction and a second image taken in a second direction simultaneously and sequentially; a first display control step of sequentially displaying the first image and the second image acquired in the image acquisition step on a display unit; a first input step of inputting a first predetermined instruction during the display of the first image and the second image performed in the first display control step; a second display control step of controlling the display of one of the first image and the second image to be fixed and the other of the first image and the second image to be continuously displayed in the case where the first predetermined instruction is input in the first input step; a second input step of inputting a second predetermined instruction during the display of the first image and the second image displayed on the display unit in the second display control step; and a synthesis step of synthesizing the first image corresponding to a time point when the first predetermined instruction is input in the first input step and the second image corresponding to a time point when the second predetermined instruction is input in the second input step.

According to still another aspect of the present invention, there is provided an image processing method used in an image processing apparatus, the method including: an image acquisition step of acquiring a first image taken in a first direction and a second image taken in a second direction in association with the imaging of the first image; a generation step of generating a plurality of candidate images each in which the second image is synthesized in one of a plurality of positions in the first image; a display control step of displaying the plurality of candidate images generated in the generation step on a display unit; a selection step of selecting a specific candidate image out of the plurality of candidate images displayed on the display unit in the display control step; and a recording control step of recording the specific candidate image selected in the selection step on a recording unit.

### BRIEF DESCRIPTION OF THE DRAWINGS

FIGS. 1A and 1B are schematic diagrams illustrating an appearance configuration of an image processing apparatus according to one embodiment of the present invention: FIG. 1A is a front view; and FIG. 1B is a back view;

FIG. 2 is a block diagram illustrating a hardware configuration of the image processing apparatus according to one embodiment of the present invention;

FIG. 3 is a functional block diagram illustrating functional components for performing bidirectional photographic processing among the functional components of the image processing apparatus illustrated in FIG. 2;

FIG. 4 is a schematic diagram illustrating an example of a front image taken by a first imaging unit 16A;

FIG. 5 is a schematic diagram illustrating an example of a back image taken by a second imaging unit 16B;

FIG. 6 is a schematic diagram illustrating a state where a free region is identified in the front image;

FIG. 7 is a schematic diagram illustrating a state where candidates for a synthesis position are identified in the front image;

FIG. 8 is a schematic diagram illustrating a state where the background image is synthesized into the front image; and

FIG. 9 is a flowchart for describing a flow of the bidirectional photographic processing performed by the image processing apparatus in FIG. 2 having the functional components in FIG. 3

### DESCRIPTION OF THE PREFERRED EMBODIMENTS

Hereinafter, preferred embodiments of the present invention will be described with reference to accompanying drawings.

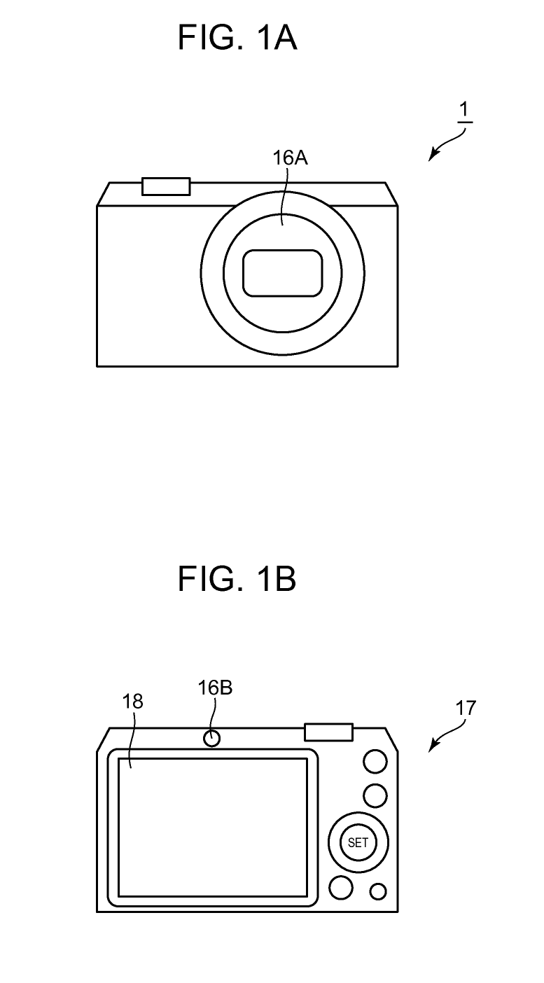

FIG. 1 is a schematic diagram illustrating an appearance configuration of an image processing apparatus according to one embodiment of the present invention: FIG. 1A is a front view; and FIG. 1B is a back view.

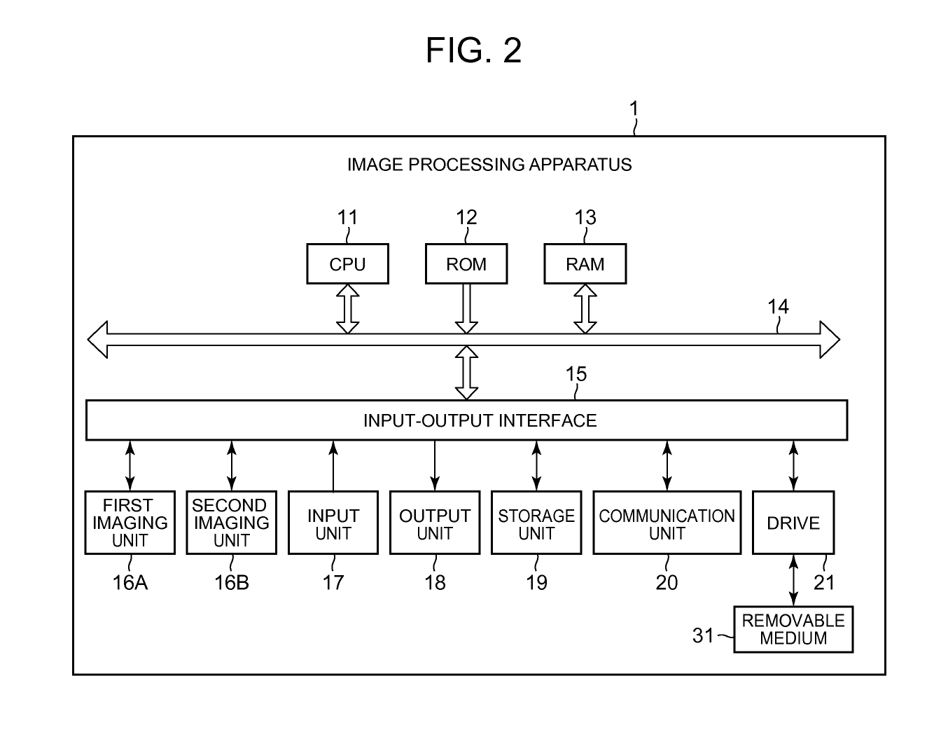

Additionally, FIG. 2 is a block diagram illustrating a hardware configuration of the image processing apparatus according to one embodiment of the present invention.

An image processing apparatus 1 is formed as, for example, a digital camera.

The image processing apparatus 1 includes a central processing unit (CPU) 11, a read-only memory (ROM) 12, a random-access memory (RAM) 13, a bus 14, an input-output interface 15, a first imaging unit 16A, a second imaging unit 16B, an input unit 17, an output unit 18, a storage unit 19, a communication unit 20, and a drive 21.

The CPU 11 performs a variety of processing according to programs recorded in the ROM 12, such as a program for bidirectional photographic processing, or programs loaded from the storage unit 19 to the RAM 13.

The RAM 13 also stores data or the like necessary for the CPU 11 to perform the variety of processing, as appropriate.

The CPU 11, the ROM 12, and the RAM 13, are connected to each other via a bus 14. The input/output interface 15 is also connected to the bus 14. The first imaging unit 16A, the second imaging unit 16B, the input unit 17, the output unit 18, the storage unit 19, the communication unit 20, and the drive 21 are connected to the input-output interface 15.

The first imaging unit 16A is disposed on the front surface side (the surface opposite to the display screen of the output unit 18) of the image processing apparatus 1 to take an image of a subject existing on the front surface side of the image processing apparatus 1. Hereinafter, the image taken by the first imaging unit 16A is referred to as “front image.”

The second imaging unit 16B is disposed on the rear surface side (on the same side as the display screen of the output unit 18) of the image processing apparatus 1 to take an image of a subject on the rear surface side of the image processing apparatus 1. Since it is assumed that the second imaging unit 16B mainly takes an image of the face of a photographer, the second imaging unit 16B is provided with a lens of a focal length such that the entire face of the photographer falls within the view angle with the image processing apparatus 1 held by the photographer for photographing. Hereinafter, the image taken by the second imaging unit 16B is referred to as “back image.”

Although not illustrated, the first imaging unit 16A and the second imaging unit 16B each include an optical lens unit and an image sensor.

The optical lens unit includes a lens for condensing light such as, for example, a focus lens, a zoom lens, and the like in order to photograph a subject.

The focus lens forms a subject image on a light receiving surface of the image sensor. The zoom lens freely changes the focal length within a certain range.

The optical lens unit is provided with peripheral circuits, as necessary, for adjusting configuration parameters such as a focal point, exposure, white balance, and the like.

The image sensor includes photoelectric conversion elements, an analog front end (AFE), and the like.

The photoelectric conversion elements are for example, complementary metal oxide semiconductor (CMOS) type photoelectric conversion elements or the like. A subject image enters the photoelectric conversion elements through the optical lens unit. Thus, by way of the photoelectric conversion elements, the subject image undergoes photoelectric conversion (imaging), image signals are accumulated for a certain period of time, and the accumulated image signals are sequentially supplied as analog signals to the AFE.

The AFE performs various signal processes such as an analog-digital (A/D) conversion process on the analog image signals. The various signal processes generate digital signals, which are output as output signals of the first imaging unit 16A or the second imaging unit 16B.

The output signals of the first imaging unit 16A or the second imaging unit 16B will be hereinafter referred to as “data on a taken image.” The data on a taken image is supplied to the CPU 11, an image processing unit which is not illustrated, or the like, as appropriate.

The input unit 17 includes various buttons or the like to input a variety of information according to user's instruction operations.

The output unit 18 includes a display, a speaker, or the like to output images and sound.

The storage unit 19 includes a hard disk, a dynamic random access memory (DRAM) or the like to store data on facial features described later, data on various images, or the like.

The communication unit 20 controls communication with other devices (not illustrated) via a network including the Internet.

A removable medium 31, which is composed of a magnetic disk, an optical disk, a magneto-optical disk, semiconductor memory or the like, is mounted on the drive 21, as appropriate. Programs which have been read by the drive 21 from the removable medium 31 are installed into the storage unit 19, as necessary. Similarly to the storage unit 19, the removable medium 31 is also able to store a variety of data such as image data stored in the storage unit 19.

Although not illustrated, the image processing apparatus 1 is able to include hardware for supporting photographing such as a strobe light emitting device, as appropriate.

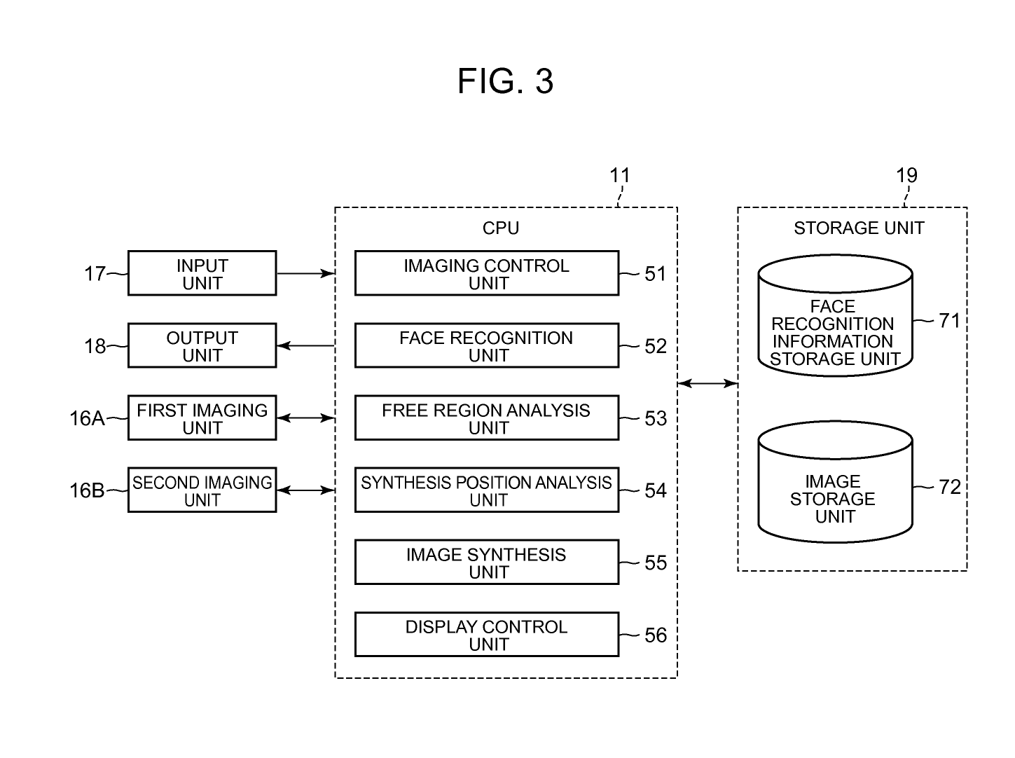

FIG. 3 is a functional block diagram illustrating functional components for performing bidirectional photographic processing among the functional components of the image processing apparatus 1 described above.

The term “bidirectional photographic processing” means a processing sequence of photographing a subject on the front surface side by using the first imaging unit 16A together with a subject on the rear surface side by using the second imaging unit 16B and synthesizing the taken image of the subject on the rear surface side into the taken image of the subject on the front surface side.

In the case of performing the bidirectional photographic processing, an imaging control unit 51, a face recognition unit 52, a free region analysis unit 53, a synthesis position analysis unit 54, an image synthesis unit 55, and a display control unit 56 function as illustrated in FIG. 3 in the CPU 11.

In addition, a face recognition information storage unit 71 and an image storage unit 72 are installed in a region of the storage unit 19.

The face recognition information storage unit 71 stores data on the features of a plurality of faces having relevance between each other. For example, the face recognition information storage unit 71 stores data on the features of faces of all the family members using the image processing apparatus 1.

The image storage unit 72 stores data on the image taken by the first imaging unit 16A, data on the image taken by the second imaging unit 16B, and data on the synthetic image synthesized by the image synthesis unit 55, as appropriate.

The imaging control unit 51 controls the first imaging unit 16A and the second imaging unit 16B to acquire live view images of the front image and the back image.

Moreover, when the shutter button is half-pressed, the imaging control unit 51 fixes the parameters of the focusing position, the aperture, the exposure, and the like to values obtained by assuming a state of photographing and controls the first imaging unit 16A to take the front image (hereinafter, referred to as “front image during half-shutter press”) expected to be acquired as a taken image.

Furthermore, when the shutter button is fully pressed, the imaging control unit 51 controls the first imaging unit 16A to take a front image for recording. Moreover, when an operation of giving an instruction of taking a back image for recording is performed, the imaging control unit 51 controls the second imaging unit 16B to take the back image for recording to be synthesized into the front image. In addition, the imaging control unit 51 controls the first imaging unit 16A to take the front image when the shutter button is fully pressed and thereafter controls the second imaging unit 16B to take the back image for recording when an operation of giving an instruction of taking the back image for recording such as fully pressing the shutter button again.

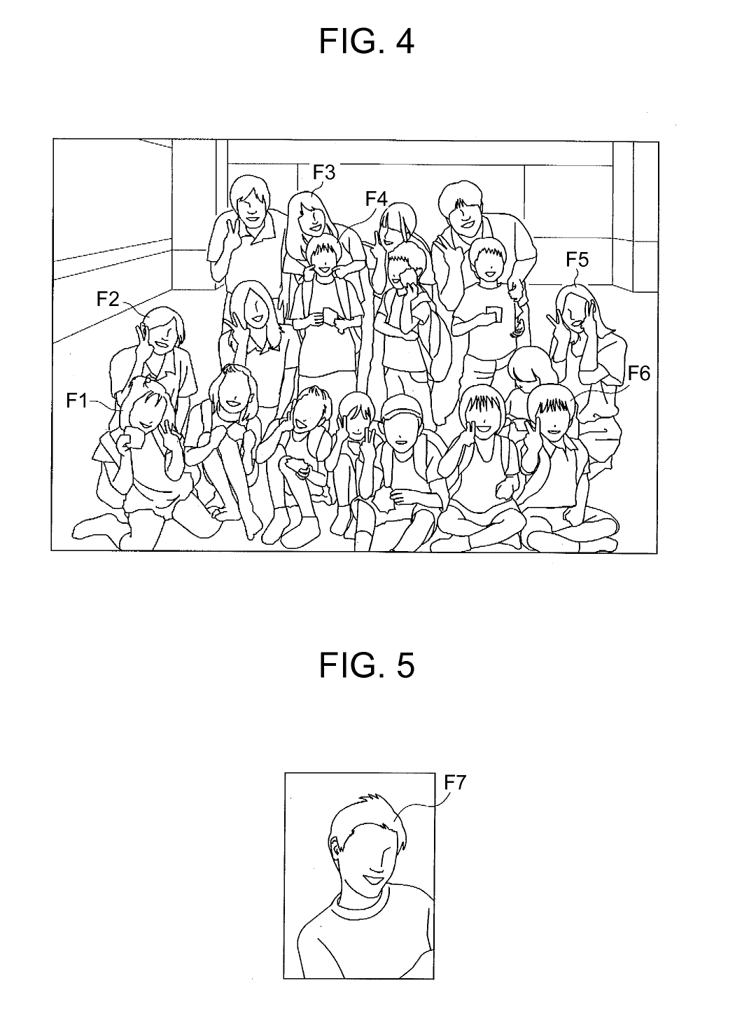

FIG. 4 is a schematic diagram illustrating an example of the front image taken by the first imaging unit 16A. FIG. 5 is a schematic diagram illustrating an example of the back image taken by the second imaging unit 16B.

FIGS. 4 and 5 illustrate an example where a person included in the back image of FIG. 5 has photographed a group photograph of a plurality of persons included in the front image of FIG. 4. In addition, assuming that the person (a subject F7) included in the back image of FIG. 5 has relevance (for example, a relationship such as “family”) with some (subjects F1 to F6) of the plurality of persons included in the front image of FIG. 4, the face recognition information storage unit 71 stores data on facial features of the person (the subject F7).

When the shutter button is half-pressed, the face recognition unit 52 recognizes the faces of the subjects included in the front image and the back image. Moreover, the face recognition unit 52 refers to data on the facial features stored in the face recognition information storage unit 71 and detects faces having relevance included in the front image and the back image.

The free region analysis unit 53 analyzes the arrangement of the subjects in the front image and identifies a region where the main subjects are not photographed as a free region. For example, the free region analysis unit 53 detects the main subjects and the background on the basis of a focusing state or the like and identifies a region where the main subjects are not photographed (in other words, the background region) as a free region.

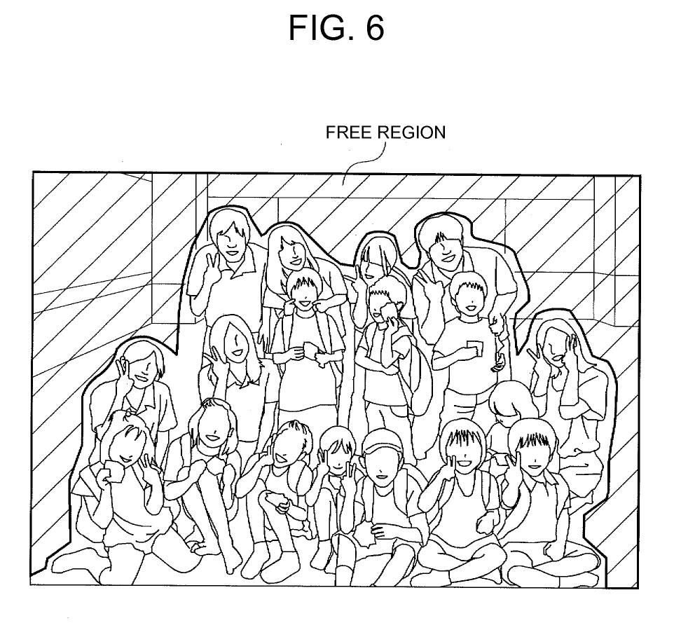

FIG. 6 is a schematic diagram illustrating a state where the free region is identified in the front image.

As illustrated in FIG. 6, the central region where the plurality of persons gather is identified as a region where the main subjects are photographed and its peripheral region is identified as a free region (the hatched area in FIG. 6) in the front image of FIG. 4.

The synthesis position analysis unit 54 analyzes the front image on the basis of the region of the faces having relevance recognized by the face recognition unit 52 and the free region identified by the free region analysis unit 53 and identifies the position (the synthesis position) where the back image is synthesized in the front image. Specifically, in the front image, the synthesis position analysis unit 54 identifies the region of the face of the subject having relevance with the face of the subject included in the back image and selects a free region near the identified region of the face. In addition, if the free region is identified in a wide range, it is possible to specify a part of the range having the set size to select the free region.

In the above, in the case where a plurality of regions of the faces of the subjects having relevance with the face of the subject included in the background image are identified in the front image, the synthesis position analysis unit 54 identifies the free regions near the regions of the individual faces as a plurality of candidates for the synthesis position of the background image. Incidentally, the synthesis position analysis unit 54 sets the priority order for the plurality of candidates for the synthesis position and selects the synthesis position according to the priority order when performing the bidirectional photographic processing. Regarding a method of setting the priority order, for example, it is possible to use the descending order of the degree of coincidence with data on facial features stored in the face recognition information storage unit 71 with respect to the region of a face, the descending order of the size of the free region, or the like.

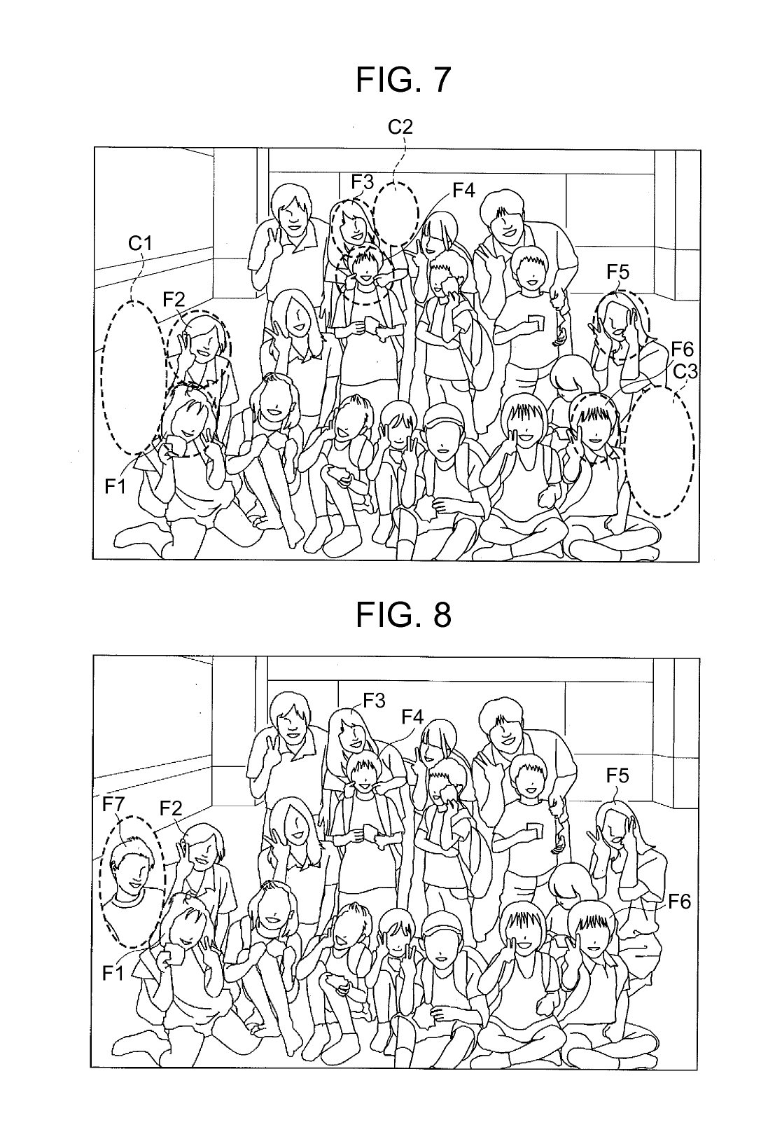

FIG. 7 is a schematic diagram illustrating a state where candidates for the synthesis position are identified in the front image.

The subjects F1 to F6 have relevance with the subject F7 as illustrated in FIG. 7 and therefore are detected as faces having relevance by the face recognition unit 52. Additionally, in the example illustrated in FIG. 7, three places (the synthesis positions C1 to C3) in the free region near the subjects F1 to F6 are identified as candidates for the synthesis position.

When the shutter button is half-pressed, the image synthesis unit 55 synthesizes a live view image of the back image in the position which is a candidate for the synthesis position identified by the synthesis position analysis unit 54 in the front image during half-shutter press. At this time, the back image at the timing when the shutter button is half-pressed may be fixedly synthesized, instead of the live view image of the back image.

Furthermore, when an operation of giving an instruction of taking the back image for recording is performed, the image synthesis unit 55 synthesizes the back image for recording taken by the second imaging unit 16B in the position which is a candidate for the synthesis position identified by the synthesis position analysis unit 54 in the front image for recording.

In this regard, in the case of synthesizing the live view image of the back image or the back image for recording in the position which is the candidate for the synthesis position in the front image, the image synthesis unit 55 resizes the size of the face detected in the back image to the size equivalent to the size of the face detected in the front image before performing the synthesis.

Thereafter, the image synthesis unit 55 stores the synthetic image of the front image for recording and the background image for recording into the image storage unit 72.

FIG. 8 is a schematic diagram illustrating a state where the background image is synthesized into the front image.

In the example illustrated in FIG. 8, the back image is synthesized in the synthesis position C1.

In the case where the live view image of the back image is synthesized, the back image taken in real time is displayed in turn in the synthesis position C1.

The display control unit 56 displays the live view images acquired by the first imaging unit 16A and the second imaging unit 16B on the display of the output unit 18. Moreover, the display control unit 56 displays the synthetic image synthesized by the image synthesis unit 55 on the display of the output unit 18. For example, the display control unit 56 displays a synthetic image of the front image during half-shutter press of the front image and the live view image of the back image or a synthetic image of the front image for recording and the back image for recording on the display of the output unit 18.

The following describes the operations.

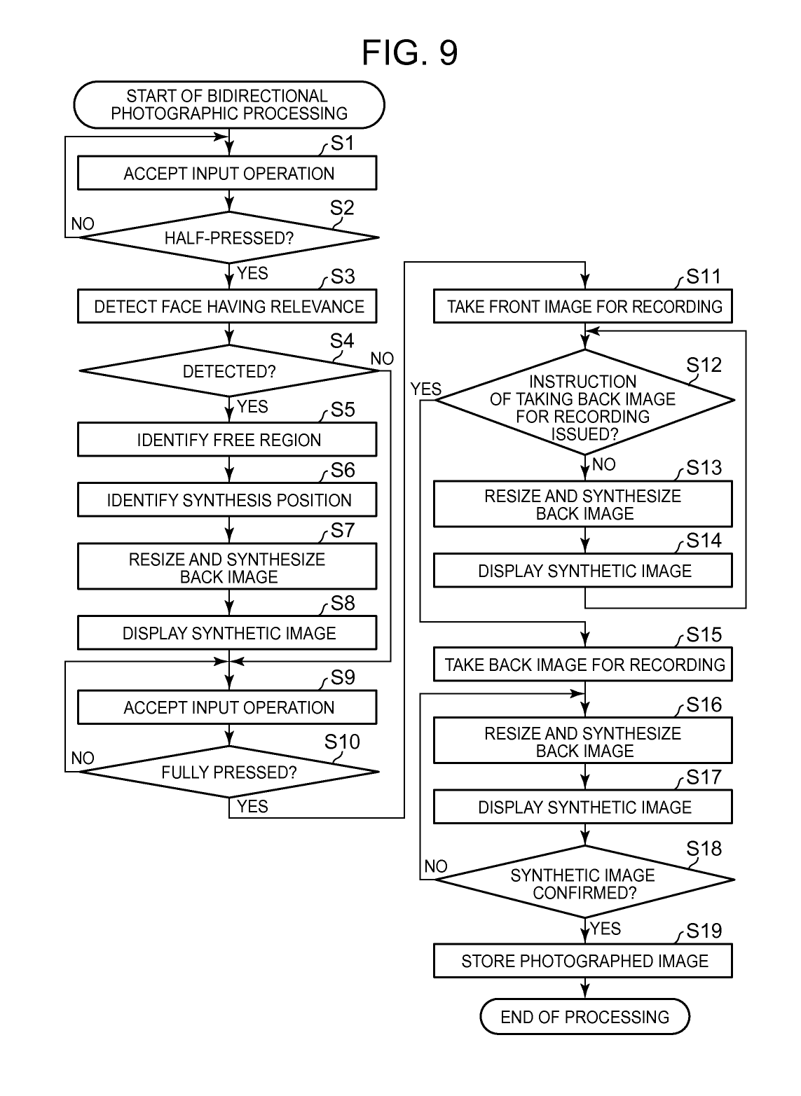

FIG. 9 is a flowchart for describing a flow of bidirectional photographic processing performed by the image processing apparatus 1 illustrated in FIG. 2 having the functional components illustrated in FIG. 3.

The bidirectional photographic processing is started by a user's operation of starting the bidirectional photographic processing on the input unit 17.

In step S1, the imaging control unit 51 accepts a user's operation on the input unit 17.

In step S2, the imaging control unit 51 determines whether the user's operation on the input unit 17 is half-pressing the shutter button.

Unless the user's operation on the input unit 17 is half-pressing the shutter button, NO is determined in step S2 and the processing moves to step S1.

On the other hand, if the user's operation on the input unit 17 is half-pressing the shutter button, YES is determined in step S2 and the processing proceeds to step S3.

In step S3, the face recognition unit 52 refers to data on the facial features stored in the face recognition information storage unit 71 and detects a face having relevance among the faces of the subjects included in the front image and the back image.

In step S4, the face recognition unit 52 determines whether the face having relevance is detected among the faces of the subjects included in the front image and the back image.

Unless the face having relevance is detected among the faces of the subjects included in the front image and the back image, NO is determined in step S4 and the processing proceeds to step S9.

On the other hand, if the face having relevance is detected among the faces of the subjects included in the front image and the back image, YES is determined in step S4 and the processing proceeds to step S5.

In step S5, the free region analysis unit 53 analyzes the arrangement of the subjects in the front image and identifies the region where the main subjects are not photographed as a free region.

In step S6, the synthesis position analysis unit 54 analyzes the front image on the basis of the region of the face having relevance recognized by the face recognition unit 52 and the free region identified by the free region analysis unit 53 and identifies the position where the back image is synthesized in the front image.

In step S7, the image synthesis unit 55 resizes the size of the face detected in the back image to the size equivalent to the size of the face detected in the front image and synthesizes the live view image of the back image in the position which is the candidate for the synthesis position identified by the synthesis position analysis unit 54 in the front image during half-shutter press.

In step S8, the display control unit 56 displays the synthetic image where the live view image of the back image is synthesized into the front image during half-shutter press.

In step S9, the imaging control unit 51 accepts a user's operation on the input unit 17.

In step S10, the imaging control unit 51 determines whether the user's operation on the input unit 17 is fully pressing the shutter button.

Unless the user's operation on the input unit 17 is fully pressing the shutter button, NO is determined in step S10 and the processing moves to step S9.

On the other hand, if the user's operation on the input unit 17 is fully pressing the shutter button, YES is determined in step S10 and the processing proceeds to step S11.

In step S11, the imaging control unit 51 controls the first imaging unit 16A to take the front image for recording.

In step S12, the imaging control unit 51 determines whether an operation of giving an instruction of taking the back image for recording has been performed. For example, the second full-press operation of the shutter button may be defined as an operation of giving an instruction of taking the back image for recording.

If the operation of giving an instruction of taking the back image for recording has been performed, YES is determined in step S12 and the processing proceeds to step S15.

Meanwhile, unless the operation of giving an instruction of taking the back image for recording has been performed, NO is determined in step S12 and the processing proceeds to step S13.

In step S13, the image synthesis unit 55 resizes the size of the face detected in the back image to the size equivalent to the size of the face detected in the front image and then synthesizes the live view image of the back image in the front image for recording.

At this time, if the face having relevance has been detected in step S4, the live view image of the back image is synthesized in the position which is the candidate for the synthesis position identified by the synthesis position analysis unit 54.

Furthermore, unless the face having relevance has been detected in step S4, the live view image of the back image is synthesized in the default position (any one of the four corners of the image for recording or the like).

In step S14, the display control unit 56 displays the synthetic image in which the live view image of the back image is synthesized into the front image for recording.

After step S14, the processing moves to step S12.

In step S15, the imaging control unit 51 controls the second imaging unit 16B to take the back image for recording which is to be synthesized into the front image for recording.

In step S16, the image synthesis unit 55 resizes the size of the face detected in the back image to the size equivalent to the size of the face detected in the front image and synthesizes the back image for recording in the front image for recording.

At this time, if the face having relevance has been detected in step S4, the image of the back image is synthesized in the position which is the candidate for the synthesis position identified by the synthesis position analysis unit 54.

Moreover, unless the face having relevance has been detected in step S4, the image of the back image is synthesized in the default position.

In step S17, the display control unit 56 displays the synthetic image where the back image for recording is synthesized in the front image for recording. At this time, if the face having relevance has been detected in step S4 and if there are a plurality of positions to be the candidates for the synthesis position identified by the synthesis position analysis unit 54 in the front image for recording, the display control unit 56 displays the synthetic image, in which the back image is synthesized in each synthesis position by the image synthesis unit 55, on the display of the output unit 18 in turn. Alternatively, however, it is possible to display the synthetic images in which the back image is synthesized in the respective synthesis positions by the image synthesis unit 55 side by side on the display of the output unit 18.

In step S18, the image synthesis unit 55 determines whether there has been performed an operation of confirming the synthetic image of the front image for recording and the back image for recording.

Specifically, in the case where the synthetic image in which the back image is synthesized in each synthesis position is displayed in turn on the display of the output unit 18, the image synthesis unit 55 determines whether there has been performed a user's operation for the synthetic image (an operation of confirming the synthetic image) currently displayed on the display among the synthetic images displayed in turn.

Moreover, in the case where the synthetic images where the back image is synthesized in the respective synthesis positions are displayed side by side on the display of the output unit 18, the image synthesis unit 55 determines whether there has been performed an operation of selecting a desired synthetic image (an operation of confirming the synthetic image) through a user's operation on the display.

Unless there has been performed the operation of confirming the synthesis position where the back image is synthesized, NO is determined in step S18 and the processing moves to step S16.

On the other hand, if there has been performed the operation of confirming the synthesis position where the back image is synthesized, YES is determined in step S18 and the processing proceeds to step S19.

In step S19, the image synthesis unit 55 stores the confirmed synthetic image of the front image for recording and the back image for recording into the image storage unit 72.

Specifically, in step S18, in the case where the synthetic image in which the back image is synthesized in each synthesis position is displayed in turn on the display of the output unit 18 and if there has been performed a user's operation for the synthetic image currently displayed on the display among the synthetic images displayed in turn, the synthetic image displayed on the display is stored in the image storage unit 72.

Moreover, in step S18, in the case where the synthetic images in which the back image is synthesized in the respective synthesis positions are displayed side by side on the display of the output unit 18 and if there has been performed an operation of selecting a desired synthetic image through a user's operation on the display, the selected synthetic image is stored in the image storage unit 72.

After step S19, the bidirectional photographic processing ends.

According to the above processing, the back image is able to be synthesized and displayed in the position having relevance with the subject of the back image in the front image.

Therefore, it is possible to generate a synthetic image more suitable for user's preference when synthesizing a plurality of images.

[Variation 1]

In the above embodiment, description has been made assuming that, when the shutter button is half-pressed, the image synthesis unit 55 fixes the front image during half-shutter press and synthesizes the live view image of the back image in the position which is a candidate for the synthesis position identified by the synthesis position analysis unit 54 in the front image during half-shutter press. In other words, the description has been made by giving an example that the front image is fixed earlier than the back image.

In contrast, it is possible to fix the back image first and then to photograph the subject of the front image at an arbitrary timing.

Specifically, a function of performing the half-shutter operation of the back image (the operation of fixing the back image) is assigned to any one of the buttons or the like in the input unit 17 in advance, and the imaging control unit 51 acquires the back image during half-shutter press according to the half-shutter operation of the back image. Thereafter, when a photographer gives an instruction of taking the front image at an arbitrary timing while observing the state of the subject of the front image in the live view image of the front image, the imaging control unit 51 acquires the front image. At this time, when the live view image of the front image is displayed, the image synthesis unit 55 may synthesize and display the back image during half-shutter press in a position, which is a candidate for the synthesis position of the front image identified by the synthesis position analysis unit 54.

Thereby, one of the front image and the back image in which the subject in a state suitable for photographing is able to be taken in preference to the other, thus enabling the other to be taken at more appropriate timing.

[Variation 2]

When the front image and the back image are taken in the above embodiment, it is possible to match the imaging conditions (shutter speed, white balance, color, brightness of the image, and the like) of the other image to those of one image. Specifically, the imaging control unit 51 is able to adjust the imaging conditions of the other image with reference to those of one image so that the brightness, color, white balance, and the like are the same between the taken front and back images.

This reduces a significant difference between the image qualities of the front and back images when the back image is synthesized into the front image, thereby achieving a synthetic image with less sense of incongruity.

[Variation 3]

Although the processing proceeds to step S9 unless a face having relevance is detected in step S4 in the above embodiment, the present invention is not limited thereto.

Specifically, unless the face having relevance is detected in step S4, the front image and the back image may be stored separately without performing synthesis of the front image and the back image.

This prevents the useless generation of a synthetic image in which the front image and the back image do not have mutual relevance.

[Variation 4]

In the above embodiment, unless the face having relevance is detected in step S4, the live view image of the back image or the back image is synthesized into the front image for recording in the default position in the processes of steps S13 and S16. The present invention is not limited thereto.

Specifically, even if the face having relevance is not detected in step S4, the free region may be identified as in the process of step S5 to synthesize the live view image of the back image or the back image in an appropriate position (for example, a position where a wide region for the synthesis is sufficiently secured) within the free region.

[Variation 5]

In the above embodiment, unless the face having relevance is detected among the faces of the subjects included in the front image and the back image in step S4, NO is determined in step S4 and the processing proceeds to step S9. The present invention, however, is not limited thereto.

Specifically, even if the face having relevance is not detected in step S4, the live view image of the back image is synthesized in the default position of the front image. Subsequently, the display control unit 56 may display the synthetic image in which the live view image of the back image is synthesized into the front image before the processing proceeds to step S9. Moreover, a free region in the front image is identified as in the process of step S5 and the live view image of the back image is synthesized in an appropriate position (for example, a position where a wide region for the synthesis is sufficiently secured) within the free region. Subsequently, the display control unit 56 may display the synthetic image in which the live view image of the back image is synthesized into the front image before the processing proceeds to step S9.

The image processing apparatus 1 configured as described above includes the imaging control unit 51, the face recognition unit 52, the synthesis position analysis unit 54, and the image synthesis unit 55.

The imaging control unit 51 acquires the first image and the second image.

The face recognition unit 52 determines relevance between the subject of the first image and the subject of the second image.

The synthesis position analysis unit 54 decides the synthesis position of the second image in the first image on the basis of the relevance of the subject determined by the face recognition unit 52.

The image synthesis unit 55 synthesizes the first image and the second image in the synthesis position determined by the synthesis position analysis unit 54.

Thereby, the second image is able to be synthesized in the position having relevance with the subject of the second image in the first image.

This enables the generation of a synthetic image more suitable for user's preference when a plurality of images are synthesized.

Furthermore, the face recognition unit 52 identifies the synthesis position of the second image in the first image at a predetermined timing related to photographing.

This enables the synthesis position of the second image in the first image to be presented to the photographer at the predetermined timing related to photographing (for example, during half-shutter operation or the like).

Furthermore, the image processing apparatus 1 includes the face recognition information storage unit 71.

The face recognition information storage unit 71 stores the predetermined relevance between the subject of the first image and the subject of the second image.

The face recognition unit 52 determines whether the subject of the first image and the subject of the second image have the predetermined relevance stored in the face recognition information storage unit 71.

The synthesis position analysis unit 54 decides the synthesis position of the second image in the first image on the basis of the predetermined relevance stored in the face recognition information storage unit 71 if the face recognition unit 52 determines that the subject of the first image and the subject of the second image have the predetermined relevance.

Thereby, the synthesis position of the second image is able to be decided with the relevance between the subject of the first image and the subject of the second image reflected on the synthesis position.

This enables the generation of a synthetic image more suitable for user's preference when a plurality of images are synthesized.

Furthermore, the image processing apparatus 1 includes a free region analysis unit 53.

The free region analysis unit 53 identifies a region where the second image is to be synthesized in the first image.

The synthesis position analysis unit 54 decides a synthesis position in the region intended for the synthesis identified by the free region analysis unit 53.

Thereby, the synthesis position for the second image is able to be decided in the region appropriate for synthesizing the second image.

Moreover, the image processing apparatus 1 includes the imaging control unit 51, the free region analysis unit 53, the synthesis position analysis unit 54, and the image synthesis unit 55.

The imaging control unit 51 acquires a first image taken in the first direction by the first imaging unit 16A and a second image taken in the second direction by the second imaging unit 16B, which is different from the first imaging unit 16A.

The free region analysis unit 53 identifies a region where the second image is to be synthesized in the first image acquired by the imaging control unit 51.

The synthesis position analysis unit 54 decides the synthesis position of the second image in the first image within the region identified by the free region analysis unit 53.

The image synthesis unit 55 synthesizes the first image and the second image in the synthesis position decided by the synthesis position analysis unit 54.

Thereby, the second image is able to be synthesized in a position having relevance with the subject of the second image taken in the second direction, which is different from the first direction, in the first image taken in the first direction.

This enables the generation of a synthetic image more suitable for user's preference when a plurality of images are synthesized.

Moreover, the image processing apparatus 1 includes the imaging control unit 51, the display control unit 56, the input unit 17, and the image synthesis unit 55.

The imaging control unit 51 simultaneously and sequentially acquires the first image taken in the first direction and the second image taken in the second direction.

The display control unit 56 sequentially displays the first image and the second image acquired by the imaging control unit 51 on the display.

The input unit 17 inputs a first predetermined instruction during the display of the first image and the second image performed by the display control unit 56.

Moreover, the display control unit 56 controls the display of one of the first and second images to be fixed and the other of the first and second images to be continuously displayed in the case where the input unit 17 inputs the first predetermined instruction.

Moreover, the input unit 17 inputs a second predetermined instruction during the display of the first image and the second image displayed on the display performed by the display control unit 56.

The image synthesis unit 55 synthesizes the first image corresponding to the time point when the input unit 17 inputs the first predetermined instruction and the second image corresponding to the time point when the input unit 17 inputs the second predetermined instruction.

Thereby, the first and second images corresponding to the timings when the predetermined instructions corresponding to the first and second images, respectively, are input can be synthesized, with respect to the first and second images taken simultaneously and sequentially.

Furthermore, the image processing apparatus 1 includes the imaging control unit 51, the image synthesis unit 55, the display control unit 56, and the input unit 17.

The imaging control unit 51 acquires a first image taken in the first direction and a second image taken in the second direction in association with the imaging of the first image.

The image synthesis unit 55 generates a plurality of candidate images each where the second image is synthesized in any one of the plurality of positions in the first image.

The display control unit 56 controls the plurality of candidate images generated by the image synthesis unit 55 to be displayed on the display.

The input unit 17 selects a specific candidate image out of the plurality of candidate images displayed on the display by the display control unit 56.

Moreover, the image synthesis unit 55 causes the image storage unit 72 to record the specific candidate image selected by the input unit 17.

This enables the synthetic image more suitable for user's preference to be easily selected out of the candidate images each where the second image is synthesized in one of the plurality of positions in the first image.

Moreover, the image synthesis unit 55 adjusts the imaging conditions of at least one of the first and second images to the imaging conditions of the other.

This reduces a significant difference between the image qualities of the first image and those of the second image when the second image is synthesized into the first image, thereby achieving a synthetic image with less sense of incongruity.

The present invention is not limited to the aforementioned embodiment. Modifications, improvements, and the like within a scope that can achieve the object of the present invention are also included in the present invention.

In the aforementioned embodiment, the present invention has been described by giving an example of taking images of subjects on the front surface side and on the back surface side of the image processing apparatus 1. The present invention, however, is not limited thereto. Specifically, the present invention is also applicable to a case of taking images in directions different from those of the above embodiment such as, for example, images on the front surface side and on the side surface side of the image processing apparatus 1 or the like.

Furthermore, in the aforementioned embodiment, the present invention has been described by giving an example of taking the front image and the back image by the image processing apparatus 1. The present invention, however, is not limited thereto. Specifically, another apparatus may be used to take one of the images such as the front image, the back image, or the like and the present invention is applicable to a case of using these images.

In the aforementioned embodiment, a digital camera has been described as an example of the image processing apparatus 1 to which the present invention is applied, but the present invention is not particularly limited thereto.

For example, the present invention is generally applicable to electronic devices, which have an image processing function. More specifically, for example, the present invention is applicable to a notebook personal computer, a video camera, a portable navigation device, a cell phone device, a smartphone, a portable game device, or the like.

The processing sequence described above is able to be executed by hardware and also able to be executed by software.

In other words, the functional components illustrated in FIG. 3 are merely an illustrative example, and the present invention is not particularly limited thereto. More specifically, the types of functional blocks employed to achieve the aforementioned functions are not particularly limited to the example of FIG. 3, as long as the image processing apparatus 1 includes the functions enabling the aforementioned processing sequence to be performed as its entirety.

A single functional block may be configured by a single piece of hardware, a single installation of software, or any combination thereof.

In a case in which the processing sequence is executed by software, a program configuring the software is installed from a network or a recording medium into a computer or the like.

The computer may be a computer embedded in dedicated hardware. Alternatively, the computer may be a computer capable of executing various functions by installing various programs, e.g., a general-purpose personal computer.

The recording medium containing such a program can not only be configured by the removable medium 31 illustrated in FIG. 2 distributed separately from the device main body for supplying the program to a user, but can also be configured by a recording medium or the like supplied to the user with being incorporated in the device main body in advance. The removable medium 31 is composed of, for example, a magnetic disk (including a floppy disk), an optical disk, a magneto-optical disk, or the like. The optical disk is composed of, for example, a compact disk-read only memory (CD-ROM), a digital versatile disk (DVD), Blu-Ray® disc, or the like. The magneto-optical disk is composed of a mini-disk (MD) or the like. The recording medium supplied to the user with being incorporated in the device main body in advance includes, for example, the ROM 12 illustrated in FIG. 2, a hard disk included in the storage unit 19 illustrated in FIG. 2 or the like, in which the program is recorded.

In the present specification, the steps describing the program recorded in the recording medium include not only processes performed in time series along the recited sequence, but also processes which are not necessarily performed in time series but are performed in parallel or individually.

Although some embodiments of the present invention have been described hereinabove, the embodiments are merely examples, and do not limit the technical scope of the present invention. Other various embodiments can be employed for the present invention, and various modifications such as omission and replacement are possible without departing from the spirit of the present invention. Such embodiments and modifications are included in the scope or subject matter of the invention described in the present specification or the like, and are included in the invention recited in the claims as well as the equivalent scope thereof.

What is claimed is:

1. An image processing apparatus comprising:
an image acquisition unit configured to acquire a first image and a second image;
a relevance determination unit configured to determine relevance between a subject of the first image and a subject of the second image;
a decision unit configured to decide a synthesis position of the second image in the first image based on the relevance between the subjects determined by the relevance determination unit; and
an image synthesis unit configured to synthesize the first image and the second image in the synthesis position decided by the decision unit.

2. The image processing apparatus according to claim 1, wherein the decision unit identifies the synthesis position of the second image in the first image at a predetermined timing related to photographing.

3. The image processing apparatus according to claim 1, further comprising a storage unit configured to store predetermined relevance between the subject of the first image and the subject of the second image, wherein:
the relevance determination unit determines whether the subject of the first image and the subject of the second image have the predetermined relevance stored in the storage unit; and
the decision unit decides the synthesis position of the second image in the first image based on the relevance in the case where the relevance determination unit determined that the subject of the first image and the subject of the second image have the predetermined relevance stored in the storage unit.

4. The image processing apparatus according to claim 1, further comprising a region identification unit configured to identify a region where the second image is to be synthesized in the first image, wherein the decision unit decides the synthesis position in the region for the synthesis identified by the region identification unit.

5. An image processing apparatus comprising:
an image acquisition unit configured to acquire a first image taken in a first direction by a first imaging unit and a second image taken in a second direction by a second imaging unit which is different from the first imaging unit;
a region identification unit configured to identify a region where the second image is to be synthesized in the first image acquired by the image acquisition unit;
a decision unit configured to decide a synthesis position of the second image in the first image in the region identified by the region identification unit; and
an image synthesis unit configured to synthesize the first image and the second image in the synthesis position decided by the decision unit.

6. An image processing apparatus comprising:
an image acquisition unit configured to acquire a first image taken in a first direction and a second image taken in a second direction simultaneously and sequentially;
a first display control unit configured to sequentially display the first image and the second image acquired by the image acquisition unit on a display unit;
a first input unit configured to input a first predetermined instruction during the display of the first image and the second image performed by the first display control unit;
a second display control unit configured to control the display of one of the first image and the second image to be fixed and the other of the first image and the second image to be continuously displayed in the case where the first input unit inputs the first predetermined instruction;
a second input unit configured to input a second predetermined instruction during the display of the first image and the second image displayed on the display unit by the second display control unit; and
a synthesis unit configured to synthesize the first image corresponding to a time point when the first input unit inputs the first predetermined instruction and the second image corresponding to a time point when the second input unit inputs the second predetermined instruction.

7. An image processing apparatus comprising:
an image acquisition unit configured to acquire a first image taken in a first direction and a second image taken in a second direction in association with the imaging of the first image;
a generation unit configured to generate a plurality of candidate images each in which the second image is synthesized in one of a plurality of positions in the first image;
a display control unit configured to display the plurality of candidate images generated by the generation unit on a display unit;
a selection unit configured to select a specific candidate image out of the plurality of candidate images displayed on the display unit by the display control unit; and
a recording control unit configured to record the specific candidate image selected by the selection unit on a recording unit.

8. The image processing apparatus according to claim 1, further comprising an adjustment unit configured to adjust the imaging conditions of at least one of the first image and the second image so as to match the imaging conditions of the other.

9. An image processing method comprising:
an image acquisition step of acquiring a first image and a second image;
a relevance determination step of determining relevance between a subject of the first image and a subject of the second image;
a decision step of deciding a synthesis position of the second image in the first image based on the relevance between the subjects determined in the relevance determination step; and
an image synthesis step of synthesizing the first image and the second image in the synthesis position decided in the decision step.

10. An image processing method used in an image processing apparatus, the method comprising:
an image acquisition step of acquiring a first image taken in a first direction by a first imaging unit and a second image taken in a second direction by a second imaging unit which is different from the first imaging unit;
a region identification step of identifying a region where the second image is to be synthesized in the first image acquired in the image acquisition step;
a decision step of deciding a synthesis position of the second image in the first image in the region identified in the region identification step; and
an image synthesis step of synthesizing the first image and the second image in the synthesis position decided in the decision step.

11. An image processing method used in an image processing apparatus, the method comprising:
an image acquisition step of acquiring a first image taken in a first direction and a second image taken in a second direction simultaneously and sequentially;
a first display control step of sequentially displaying the first image and the second image acquired in the image acquisition step on a display unit;
a first input step of inputting a first predetermined instruction during the display of the first image and the second image performed in the first display control step;
a second display control step of controlling the display of one of the first image and the second image to be fixed and the other of the first image and the second image to be continuously displayed in the case where the first predetermined instruction is input in the first input step;
a second input step of inputting a second predetermined instruction during the display of the first image and the second image displayed on the display unit in the second display control step; and
a synthesis step of synthesizing the first image corresponding to a time point when the first predetermined instruction is input in the first input step and the second image corresponding to a time point when the second predetermined instruction is input in the second input step.

12. An image processing method used in an image processing apparatus, the method comprising:
an image acquisition step of acquiring a first image taken in a first direction and a second image taken in a second direction in association with the imaging of the first image;
a generation step of generating a plurality of candidate images each in which the second image is synthesized in one of a plurality of positions in the first image;
a display control step of displaying the plurality of candidate images generated in the generation step on a display unit;
a selection step of selecting a specific candidate image out of the plurality of candidate images displayed on the display unit in the display control step; and
a recording control step of recording the specific candidate image selected in the selection step on a recording unit.
